(19) United States
(12) Patent Application Publication
(10) Pub. No.: US 2026/0260181 A1
(43) Pub. Date: Sep. 3, 2026

(54) APPARATUS FOR MANAGING NON-CONFORMANCE ANOMALIES IN A STRUCTURE AND ASSOCIATED SYSTEM AND METHOD

(71) Applicant: The Boeing Company, Arlington, VA (US)

(72) Inventors: Benjamin Pate, Renton, WA (US); Gregg Paporello, Wichita, KS (US)

(21) Appl. No.: 19/067,164

(22) Filed: Feb. 28, 2025

(51) Int. Cl. G06Q 10/063

(52) U.S. Cl. CPC G06Q 10/063

(57) ABSTRACT

Disclosed herein is an apparatus and associated system and method for managing non-conformance anomalies in a structure. The apparatus generates a digital representation of the structure, maps anomalies, defines dynamically adjustable zones, and associates anomalies with corresponding zones. Each zone is linked to an inspection plan, which outlines anomaly evaluation criteria and corrective actions. The system automatically executes the inspection plan and generates instructions to guide corrective actions on the real structure. This dynamic, zone-based approach improves anomaly tracking, assessment, and resolution, to enable structured and adaptable anomaly management for manufacturing, maintenance, and repair applications.

### FIELD

This disclosure relates generally to anomaly management systems and more particularly to a dynamic zone-based system for managing non-conformance anomalies in a structure.

### BACKGROUND

Managing non-conformance (NC) anomalies in large or complex structures, such as aircraft, rockets, microchips, and other assemblies, can present significant challenges due to the volume and complexity of anomalies. Conventional anomaly tracking methods rely on static, location-based methods that rigidly divide structures into predefined sections. However, these methods do not scale efficiently for large or complex structures where anomalies may appear in unpredictable locations across extensive areas. Additionally, static systems lack flexibility and fail to adapt to operational changes, such as accessibility constraints, evolving inspection priorities, or changes in structural configurations over time.

These static systems often result in inefficient inspections, misaligned resource allocation, and an inability to adapt anomaly management strategies to real-world conditions. As a result, conventional inspections may become time-consuming, costly, and less effective in identifying and addressing critical anomalies.

The subject matter of the present application has been developed in response to the present state of the art, and in particular, in response to the shortcomings of anomaly management systems, that have not yet been fully solved by currently available techniques. Accordingly, the subject matter of the present application has been developed to provide an apparatus for managing non-conformance anomalies and an associated system and method that overcome at least some of the above-mentioned shortcomings of prior art techniques.

The following is a non-exhaustive list of examples, which may or may not be claimed, of the subject matter, disclosed herein.

Disclosed herein is an apparatus for managing non-conformance anomalies in a structure, including a processor and a memory that stores code executable by the processor. The apparatus defines a plurality of zones within a digital representation of the structure. A size of each one of the plurality of zones is dynamically adjustable. Each one of the plurality of zones is associated with a corresponding one of a plurality of inspection plans that are different from one another. The apparatus dynamically adjusts the size of at least one of the plurality of zones based on operational requirements of the digital representation of the structure. The apparatus also maps a plurality of anomalies identified by an anomaly identification system to corresponding locations within the digital representation of the structure and dynamically associates each one of the plurality of anomalies with a corresponding one of the plurality of zones within the digital representation of the structure. The apparatus further automatically executes the inspection plan associated with the zone of the plurality of zones and generate instructions to guide at least one corrective action for each one of the plurality of anomalies. The instructions associated with each corresponding one of the plurality of anomalies are generated according to the inspection plan for the zone associated with the corresponding one of the plurality of anomalies. The preceding subject matter of this paragraph characterizes example 1 of the present disclosure.

The apparatus subdivides at least one of the plurality of zones into a plurality of sub-zones within the digital representation of the structure. A size of each one of the plurality of sub-zones is dynamically adjustable. Each one of the plurality of sub-zones is associated with a corresponding one of a plurality of inspection plans that are different from one another. The apparatus also dynamically associates at least one of the plurality of anomalies with a corresponding one of the plurality of sub-zones within the digital representation of the structure. The apparatus further automatically executes the inspection plan associated with the sub-zone of the plurality of sub-zones and generates instructions to guide at least one correction action for each one of the plurality of anomalies associated within the plurality of sub-zones. The instructions associated with each corresponding one of the plurality of anomalies are generated according to the inspection plan for the sub-zone associated with the corresponding one of the plurality of anomalies. The preceding subject matter of this paragraph characterizes example 2 of the present disclosure, wherein example 2 also includes the subject matter according to example 1, above.

The apparatus defines a plurality of segments within the digital representation of the structure. Each one of the plurality of segments represents a predefined portion of the digital representation of the structure. The plurality of segments are configured to organize the digital representation of the structure into identifiable regions for managing the plurality of anomalies. The apparatus defines at least one of the plurality of zones within a corresponding one of the plurality of segments within the digital representation of the structure. The preceding subject matter of this paragraph characterizes example 3 of the present disclosure, wherein example 3 also includes the subject matter according to any of examples 1-2, above.

Each corresponding one of the plurality of anomalies identified by the anomaly identification system is identified by a three-point location within the digital representation of the structure. The three-point location is defined relative to a reference plane and includes a horizontal position measured along a first axis parallel to the reference plane, a vertical position measured along a second axis perpendicular to the reference plane, and a longitudinal position measured along a third axis extending along a length of the digital representation of the structure and intersecting the reference plane. The preceding subject matter of this paragraph characterizes example 4 of the present disclosure, wherein example 4 also includes the subject matter according to any of examples 1-3, above.

The three-point location of each corresponding one of the plurality of anomalies is used to dynamically associate each corresponding one the plurality of anomalies with a corresponding one of the plurality of zones within the digital representation of the structure. The preceding subject matter of this paragraph characterizes example 5 of the present disclosure, wherein example 5 also includes the subject matter according to example 4, above.

The step of defining a plurality of zones within the digital representation of the structure includes automatically defining each one of the plurality of zones based on operational requirements of the digital representation of the structure and automatically associating the inspection plan corresponding to each one of the plurality of zones. The preceding subject matter of this paragraph characterizes example 6 of the present disclosure, wherein example 6 also includes the subject matter according to any of examples 1-5, above.

The step of defining a plurality of zones within the digital representation of the structure includes enabling a user to manually define boundaries for each one of the plurality of zones and manually associating the inspection plan corresponding to each one of the plurality of zones. The preceding subject matter of this paragraph characterizes example 7 of the present disclosure, wherein example 7 also includes the subject matter according to any of examples 1-6, above.

Anomaly characteristics are determined for each one of the plurality of anomalies identified by the anomaly identification system. The anomaly characteristics include at least one of a location of each one of the plurality of anomalies, a type of each one of the plurality of anomalies, a size of each one of the plurality of anomalies, a severity level of each one of the plurality of anomalies, and a status of each one of the plurality of anomalies. The preceding subject matter of this paragraph characterizes example 8 of the present disclosure, wherein example 8 also includes the subject matter according to any of examples 1-7, above.

The digital representation of the structure is updated in real-time based on at least one of newly identified anomalies, changes in anomaly status of at least one the plurality of anomalies, or adjustments to the plurality of zones. The preceding subject matter of this paragraph characterizes example 9 of the present disclosure, wherein example 9 also includes the subject matter according to any of examples 1-8, above.

Further disclosed herein is a non-conformance anomaly management system including a structure including a plurality of anomalies and an apparatus. Each one of the plurality of anomalies requires at least one corrective action. The apparatus includes a processor and a memory that stores code executable by the processor. The apparatus defines a plurality of zones within a digital representation of the structure. A size of each one of the plurality of zones is dynamically adjustable. Each one of the plurality of zones is associated with a corresponding one of a plurality of inspection plans that are different from one another. The apparatus dynamically adjusts the size of at least one of the plurality of zones based on operational requirements of the digital representation of the structure. The apparatus also maps a plurality of anomalies identified by an anomaly identification system to corresponding locations within the digital representation of the structure and dynamically associates each one of the plurality of anomalies with a corresponding one of the plurality of zones within the digital representation of the structure. The apparatus further automatically executes the inspection plan associated with the zone of the plurality of zones and generate instructions to guide at least one corrective action for each one of the plurality of anomalies. The instructions associated with each corresponding one of the plurality of anomalies are generated according to the inspection plan for the zone associated with the corresponding one of the plurality of anomalies. At least one corrective action is performed for each one of the plurality of anomalies of the structure based on the instructions generated by the apparatus derived from the digital representation of the structure. The preceding subject matter of this paragraph characterizes example 10 of the present disclosure.

The anomaly management system subdivides at least one of the plurality of zones into a plurality of sub-zones within the digital representation of the structure. A size of each one of the plurality of sub-zones is dynamically adjustable. Each one of the plurality of sub-zones is associated with a corresponding one of a plurality of inspection plans that are different from one another. The system dynamically associates at least one of the plurality of anomalies with a corresponding one of the plurality of sub-zones within the digital representation of the structure. The system further automatically executes the inspection plan associated with the sub-zone of the plurality of sub-zones, and generates instructions to guide at least one correction action for each one of the plurality of anomalies associated within the plurality of sub-zones, wherein the instructions associated with each corresponding one of the plurality of anomalies are generated according to the inspection plan for the sub-zone associated with the corresponding one of the plurality of anomalies. The preceding subject matter of this paragraph characterizes example 11 of the present disclosure, wherein example 11 also includes the subject matter according to example 10, above.

The anomaly management system defines a plurality of segments within the digital representation of the structure. Each one of the plurality of segments corresponds to a predefined portion within the digital representation of the structure, and the plurality of segments are configured to organize the digital representation of the structure into identifiable regions for managing the plurality of anomalies. The system also defines at least one of the plurality of zones within a corresponding one of the plurality of segments within the digital representation of the structure. The preceding subject matter of this paragraph characterizes example 12 of the present disclosure, wherein example 12 also includes the subject matter according to any of examples 10-11, above.

Each corresponding one of the plurality of anomalies identified by an anomaly identification system is identified by a three-point location within the digital representation of the structure. The three-point location is defined within the digital representation relative to a reference plane and includes a horizontal position measured along a first axis parallel to the reference plane, a vertical position measured along a second axis perpendicular to the reference plane, and a longitudinal position measured along a third axis extending along a length of the structure and intersecting the reference plane. The preceding subject matter of this paragraph characterizes example 13 of the present disclosure, wherein example 13 also includes the subject matter according to any of examples 10-12, above.

Anomaly characteristics are determined for each one of the plurality of anomalies identified by the anomaly identification system. The anomaly characteristics include at least one of a location of each one of the plurality of anomalies, a type of each one of the plurality of anomalies, a size of each one of the plurality of anomalies, a severity level of each one of the plurality of anomalies, and a status of each one of the plurality of anomalies. The preceding subject matter of this paragraph characterizes example 14 of the present disclosure, wherein example 14 also includes the subject matter according to any of examples 10-13, above.

The digital representation of the structure is updated in real-time based on at least one of newly identified anomalies, changes in anomaly status of at least one the plurality of anomalies, or adjustments to the plurality of zones. The preceding subject matter of this paragraph characterizes example 15 of the present disclosure, wherein example 15 also includes the subject matter according to any of examples 10-16, above.

Further disclosed herein is a method of managing non-conformance anomalies in a structure. The method includes identifying a plurality of anomalies within the structure using an anomaly identification system. The method also includes mapping each one of the plurality of anomalies to corresponding locations within a digital representation of the structure. The method further includes defining a plurality of zones within the digital representation of the structure. A size of each one of the plurality of zones is dynamically adjustable and associated with a corresponding one of a plurality of inspection plans that are different from one another. The method additionally includes dynamically adjusting at least one of the plurality of zones within the digital representation of the structure based on operational requirements of the structure and dynamically associating each one of the plurality of anomalies with a corresponding one of the plurality of zones within the digital representation of the structure. The method also includes automatically executing the inspection plan associated with the corresponding one of the plurality of zones and performing at least one corrective action for each one of the plurality of anomalies within the structure according to the inspection plan for the zone associated with the corresponding one of the plurality of anomalies. The preceding subject matter of this paragraph characterizes example 16 of the present disclosure.

The method includes subdividing at least one of the plurality of zones within the digital representation of the structure into a plurality of sub-zones. A size of each one of the plurality of sub-zones is dynamically adjustable and each one of the plurality of sub-zones is associated with a corresponding one of a plurality of inspection plans. The preceding subject matter of this paragraph characterizes example 17 of the present disclosure, wherein example 17 also includes the subject matter according to example 16, above.

The method includes defining the digital representation of the structure into a plurality of segments. Each one of the plurality of segments corresponds to a predefined portion of the digital representation of the structure and defining at least one of the plurality of zones within a corresponding one of the plurality of segments in the digital representation of the structure. The preceding subject matter of this paragraph characterizes example 18 of the present disclosure, wherein example 18 also includes the subject matter according to any of examples 16-17, above.

The method includes determining a three-point location within the digital representation of the structure for each one of the plurality of anomalies relative to a reference plane. The three-point location including a horizontal position, a vertical position, and a longitudinal position. The preceding subject matter of this paragraph characterizes example 19 of the present disclosure, wherein example 19 also includes the subject matter according to any of examples 16-18, above.

The method includes generating the digital representation of the structure, in real-time, based on at least one of newly identified anomalies, changes in anomaly status for at least one of the plurality of anomalies, or adjustments to the plurality of zones. The preceding subject matter of this paragraph characterizes example 20 of the present disclosure, wherein example 20 also includes the subject matter according to any of examples 16-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic diagram of an apparatus for managing non-conformance anomalies in a structure, according to one or more examples of the present disclosure;

FIG. 2A is a schematic table illustrating a segmented division of a digital representation of a structure, which defines the segments into a plurality of zones, according to one or more examples of the present disclosure;

FIG. 2B is a schematic table illustrating the segmented division of the digital representation of the structure of FIG. 2A, which further defines at least one of the plurality of zones into a plurality of sub-zones, according to one or more examples of the present disclosure;

FIG. 3A is a graphical representation of one example of a structure, with a plurality of segments and a plurality of zones defined within the structure, according to one or more examples of the present disclosure;

FIG. 3B is a graphical representation of the structure of FIG. 3A, with the plurality of segments, the plurality of zones, and a plurality of sub-zones defined for an exterior portion of the structure, according to one or more examples of the present disclosure;

FIG. 3C is a graphical representation of the structure of FIG. 3A, with the plurality of segments and the plurality of zones defined for an interior portion of the structure, according to one or more examples of the present disclosure;

FIG. 4A is a schematic table illustrating a location of a plurality of anomalies, according to one or more examples of the present disclosure;

FIG. 4B is a schematic side view of a representative structure showing the location of a plurality of anomalies, including the plurality of anomalies of FIG. 4A, according to one or more examples of the present disclosure;

FIG. 5 is a schematic graphical representation of anomaly occurrences within corresponding ones of a plurality of zones and a plurality of sub-zones, according to one or more examples of the present disclosure;

FIG. 6 is a schematic graphical representation illustrating the association of inspection plans with corresponding zones and sub-zones, along with the plurality of anomalies identified within each zone or sub-zone, according to one or more examples of the present disclosure;

FIG. 7 is a schematic perspective view of a non-conformance anomaly management system, according to one or more examples of the present disclosure; and

FIG. 8 is a schematic flow diagram of a method of managing non-conformance anomalies in a structure, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein is an apparatus and associated system and method for managing non-conformance anomalies in a structure. As used herein, non-conformance (NC) anomalies refers to deviations from predefined design, manufacturing, or operational specifications, including but not limited to defects and other anomalies affecting the performance, integrity, reliability, or appearance of the structure. NC anomalies, hereinafter referred to as “anomalies”, can arise from material inconsistencies, assembly errors, environmental damage, fatigue, or other factors that cause a component or system to fall outside acceptable tolerances. These anomalies may require assessment, tracking, and corrective action to ensure compliance with safety and performance standards.

The disclosed apparatus provides a dynamic, zone-based anomaly management approach that improves tracking, assessment, and resolution of anomalies. The apparatus translates anomaly data from various sources into a structured format within a digital representation of the structure. Accordingly, the apparatus maps anomalies onto a digital representation of the structure, defines adjustable inspection zones, and associate anomalies with corresponding zones. Each zone is not statically defined; rather, zones can be reconfigured based on operational requirements, including structural changes or inspection priorities, while maintaining anomaly associations. This ensures that anomaly tracking remains accurate even as zones are resized, merged, or divided in response to evolving conditions.

The apparatus is particularly beneficial for large and/or complex structures and assemblies, such as aircraft, ships, industrial equipment, or large infrastructure components. The dynamic nature of the zones enables the system to be adaptable across different phases of a structure’s lifecycle, including manufacturing, quality control, maintenance, and repair operations. The disclosed apparatus allows for real-time updates to the digital representation of the structure as anomalies are identified, an anomaly status change, or zones are adjusted. The ability to dynamically manage anomalies within an evolving structural framework enhances efficiency in anomaly tracking and improves overall anomaly resolution workflows.

In some examples, the disclosed apparatus and system may be configured to interface with external anomaly management tools, quality management systems (QMS), or inspection databases. This interoperability allows anomaly data and mapping data to be imported from external sources, such as CAD models, digital twin platforms, or manual inspection records, to ensure seamless integration with existing workflows.

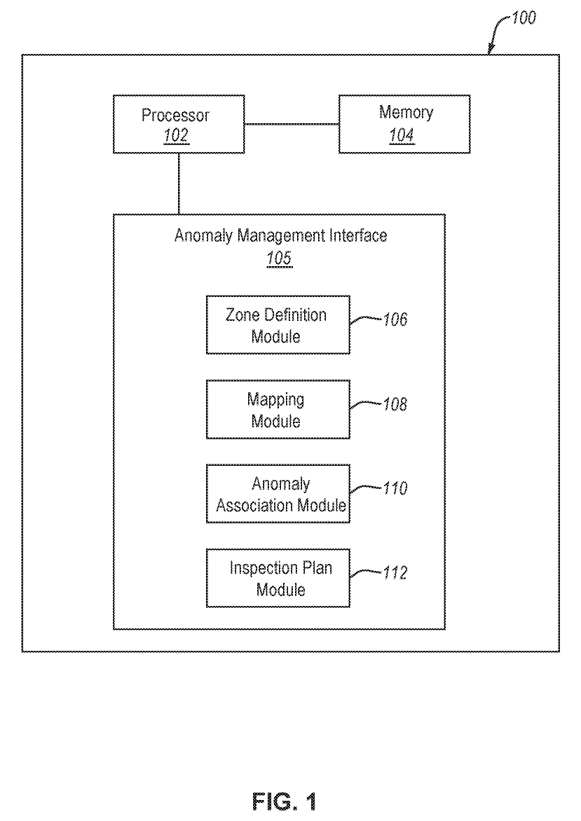

FIG. 1 shows one example of an apparatus 100 for managing anomalies in a structure. As used herein, a structure refers to a physical object or assembly subject to anomaly monitoring and corrective action. This includes large or complex structures including, but not limited to, aircraft fuselages, aircraft wings, ship hulls, automotive chassis, industrial pipelines, and composite assemblies. Throughout this description, an aircraft fuselage is used as a non-limiting example to illustrate the functionality of the disclosed apparatus. However, the apparatus 100 and associated system and method may be applied to various other structures without departing from the scope of the disclosure.

The apparatus 100 includes a processor 102 and a memory 104. The memory 104 stores code executable by the processor 102 to perform anomaly management functions. The processor 102 and memory 104 are communicatively linked to an anomaly management interface 105, which facilitates various operations related to anomaly identification, tracking, and corrective action planning. The anomaly management interface 105 includes multiple modules, including but not limited to, a zone definition module 106, a mapping module 108, an anomaly association module 110, and an inspection plan module 112.

The zone definition module 106 is configured to define a plurality of zones within a digital representation of a structure. As used herein, the digital representation of the structure refers to a virtual model or mapped dataset corresponding to a physical structure. The digital representation may be generated from CAD Models, sensor data, inspection records, or other data sources that reflect the physical characteristics, anomaly locations, and zoning configurations of the physical structure. Each zone represents a designated inspection area within the digital representation of the structure that allows for systematic anomaly tracking and evaluation.

The plurality of zones may be initially defined based on at least one of the structural characteristics, function, or stage of assembly of the digital representation of the structure. In some examples, defining zones based on structural characteristics involves dividing the digital representation into regions that correspond to physical components, such as the fuselage, wings, or tail of an aircraft. This approach helps to align inspections with the structural layout, making it easier to track anomalies within specific structural elements. Zones may also be defined based on function, where each zone corresponds to a particular operational role within the structure. For example, in an aircraft, functional zones may be created for areas related to pressurization systems, avionics, or structural reinforcements, enabling targeted inspections based on critical functions. Additionally, or alternatively, zones may be determined according to stage of assembly, allowing inspections to remain aligned with evolving manufacturing or maintenance needs. For example, during initial assembly, zones may focus on areas where structural bonding is performed, while in later stages, zones may be adjusted within the digital representation to account for accessibility constraints when certain parts are fully integrated.

The plurality of zones are dynamically adjustable, meaning that their size, shape, and/or coverage (e.g., corresponding boundaries) can be modified in response to operational requirements of the digital representation of the structure. That is, as the needs of the digital representation of the structure may change over time, the plurality of zones are dynamically adjustable in response to operational requirements. As used herein, operational requirements refer to factors that influence the configuration, adjustment, or execution of inspection and anomaly management processes. These factors may include, but are not limited to, changes in accessibility, shifting inspection priorities, structural modifications during manufacturing, maintenance, or repair, environmental conditions, regulatory compliance considerations, and system performance constraints. For example, a zone may be expanded to cover a larger inspection area when broader anomaly assessment is needed, such as after a major structural modification. Conversely, a zone may be reduced in size to focus on a specific smaller section. The ability to dynamically adjust zones ensures that inspections remain efficient and responsive to evolving conditions.

In some examples, the zone definition module 106 is configured to automatically define each one of the plurality of zones based on operational requirements of the digital representation of the structure. By leveraging these operational requirements, the zone definition module 106 can dynamically establish zones in a manner that may optimizes inspection efficiency. In other examples, the zone definition module 106 is configured to enable a user to manually define boundaries for each one of the plurality of zones 124. Manual zone definition allows users to incorporate specific knowledge of structural nuances, accessibility constraints, or unique inspection priorities that may not be fully captured by predefined operational requirements. Through a user interface, a user can delineate zone boundaries based on practical considerations such as ease of access, visibility, or the complexity of inspection procedures required. In yet other examples, the definition of zones within the digital representation of the structure may be a combination of both automatic and manual processes, to allow users to refine or adjust automatically generated zones based on real-world inspection needs.

Each zone is associated with a corresponding inspection plan. The inspection plan defines the scope, criteria, and procedures for evaluating the zone, including general inspections for and assessments of specific anomalies within the zone, when applicable. Each one of the plurality of zones is associated with a corresponding one of a plurality of inspection plans that are different from one another. That is, each inspection plan is uniquely tailored to its respective zone, meaning that inspection plans are based on specific characteristics and requirements of that zone. Accordingly, an inspection plan applies exclusively to the zone with which it is associated.

In some examples, the inspection plan corresponding to each zone is automatically associated based on predefined criteria, such as zone characteristics, inspection history, or structural importance. This automation allows for efficient and data-driven inspection planning, to ensure that each zone is assigned an appropriate inspection plan based on its specific attributes. In other examples, a user may manually associate an inspection plan with a zone, allowing for flexibility in adapting inspection requirements based on specific knowledge, priorities, or real-time considerations. In yet other examples, inspection plan association may be a combination of both automatic and manual processes, where automatically assigned inspection plans can be reviewed or modified by a user as needed.

An inspection plan may specify general inspection criteria for the entire zone and/or include targeted inspection instructions for specific anomalies. For example, if a zone includes two hundred rivets, the inspection plan may require a general assessment of all rivets, ensuring that each rivet meets quality and safety standards. Additionally, or alternatively, the inspection plan may include specific instructions to inspect a portion of the rivets having pre-identified anomalies and specific instructions to inspect and verify those rivets individually. This approach allows for flexible anomaly management, as each inspection plan can specify a generalized inspection procedure for zones without pre-identified anomalies, while inspection plans for zones containing known anomalies can incorporate more specific inspections procedures.

In some examples, before defining the plurality of zones, the zone definition module 106 may first divide the digital representation of the structure into segments. Segments serve as a broader structural division than the plurality of zones and help organize large or complex structures into manageable sections before zone definition occurs. Accordingly, segmentation is applied in a manner that reflects the physical organization of the structure.

Segments are predefined based on structural or operational factors and remain fixed throughout anomaly management, whereas zones within each segment are dynamically adjustable to accommodate real-time inspection and maintenance needs. Within the digital representation, segmentation is particularly useful when a structure is too large to manage effectively as a single entity or when its components are naturally divided based on assembly, accessibility, or operational function. For example, a digital representation of an aircraft fuselage may be segmented into Segment A, Segment B, Segment C, Segment D, Segment E, and up to Segment N, where each segment represents a distinct portion of the fuselage used in manufacturing and maintenance planning. Segment N represents the Nth segment in the sequence, corresponding to a final section of the digital representation of the structure.

Segmentation alone does not dictate inspection plans, but it does provide a structured framework that facilitates efficient zone definition within the digital representation. Since segments remain fixed, zones are defined within them to allow for flexible, real-time anomaly management and inspection adjustments. Conversely, for smaller or less complex structures, segmentation may not be necessary, and zones can be defined directly across the entirety of the digital representation of the structure.

In some examples, the zone definition module 106 may subdivide at least one of the plurality of zones into a plurality of sub-zones within the digital representation of the structure. Each sub-zone represents a smaller, more granular division within a zone, allowing for refined inspection planning and anomaly management within the digital representation. Accordingly, sub-zones enable a more detailed focus on specific areas that may require distinct inspection procedures or anomaly assessments, compared to the broader zone. Within the digital representation, subdividing zones into sub-zones may be beneficial when certain areas within a zone have different inspection requirements, accessibility constraints, or anomaly concentrations. For example, different parts of a component in the digital representation may experience varying stress levels, environmental exposure, or manufacturing tolerances, necessitating different inspection techniques or criteria.

Each sub-zone is dynamically adjustable within the digital representation, meaning its size (e.g., boundaries) can be modified based on operational requirements, similar to zones. The dynamic adjustability of sub-zones ensures that inspections remain responsive to changes in accessibility, inspection priorities, or structural modifications reflected in the digital representation. Additionally, each sub-zone is associated with a corresponding inspection plan that defines the scope, criteria, and procedures for evaluating anomalies within that sub-zone. The inspection plan for each sub-zone is distinct from others, allowing for tailored inspection requirements based on specific characteristics of the sub-zone in the digital representation. In some examples, sub-zones may themselves by further subdivided to allow for a hierarchical structuring of inspection areas that can be refined iteratively to accommodate evolving operational needs.

The zone definition module 106 is further configured to dynamically adjust the size of at least one of the plurality of zones based on operational requirements of the digital representation of the structure. Unlike merely defining the zones, dynamic adjustment actively modifies zone boundaries in real-time based on evolving factors. For examples, if a section of the digital representation of the structure becomes temporarily inaccessible due to assembly progress, the associated zone may be redefined to exclude that section until access is restored. Conversely, if an emerging anomaly trend indicated a need for broader inspection coverage, a zone may be expanded to encompass a larger area.

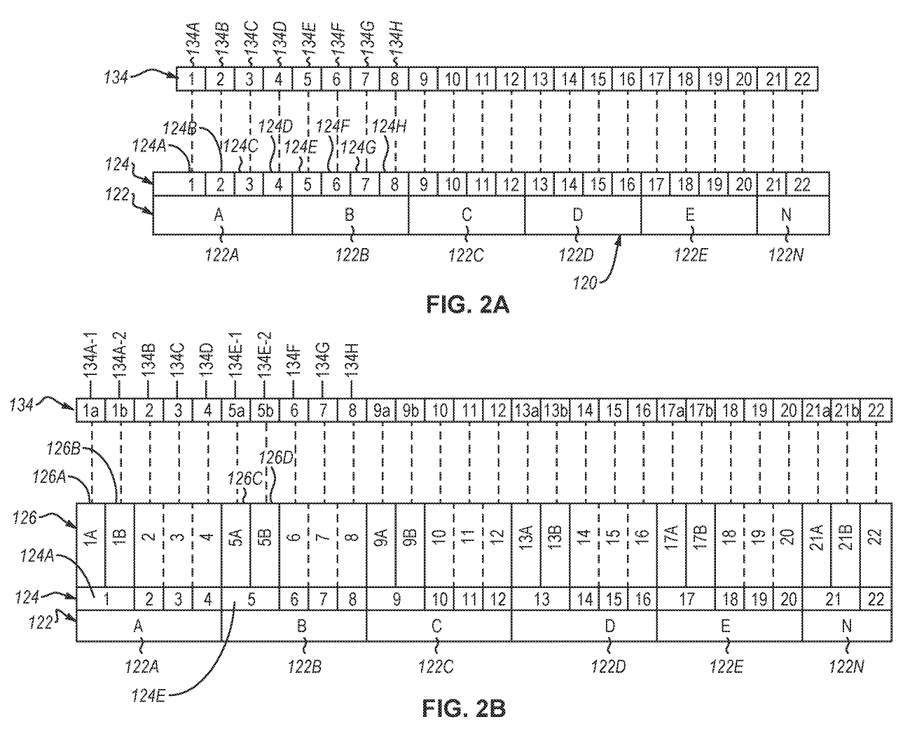

Referring to FIG. 2A, a table illustrating one example of a digital representation 120 of a structure defined into a plurality of zones 124 is shown. As described above, in some examples, the digital representation 120 of the structure is segmented into a plurality of segments 122 before the plurality of zones 124 are defined. For example, the plurality of segments 122 may include a first segment 122A, a second segment 122B, a third segment 122C, a fourth segment 122D, a fifth segment 122E, and an Nth segment 122N, where N represents the last segment of the digital representation based on the predefined segmentation. Segmentation provides an initial structural framework to improve anomaly management and inspection planning. In other examples, the digital representation 120 of the structure is not segmented into a plurality of segment and only includes a plurality of zones 124.

The plurality of zones 124 are defined within the digital representation 120 of the structure , with at least one zone 124 being established within a corresponding one of the plurality of segments 122, when segmentation is used. For example, in the digital representation, the first segment 122A includes a first zone 124A, a second zone 124B, a third zone 124C, a fourth zone 124D, while the second segment 122B includes a fifth zone 124E, a sixth zone 124F, a seventh zone 124G, and an eighth zone 124H. Thus, both the first segment 122A and second segment 122B contains multiple zones 124. In other examples, the number of zones 124 per segment 122 may vary based on structural complexity, anomaly distribution, or other inspection requirements. For instances, a segment may only define a single zone, whereas other segments may include multiple zones to accommodate more detailed inspections. This segmentation and zoning structure within the digital representation helps to ensure that each defined zone remains a manageable unit for inspection and anomaly tracking. For simplicity, not all zones are labeled in FIGS. 2A-6, and additional zones may be present within the digital representation 120 of the structure .

Each one of the plurality of zones 124 is associated with a corresponding one of a plurality of inspection plans 134. For example, the first zone 124A can be associated with a first inspection plan 134A, the second zone 124B with a second inspection plan 134B, the third zone 124C with a third inspection plan 134C, the fourth zone 124D with a fourth inspection plan 134D, the fifth zone with a fifth inspection plan 134E, the sixth zone 124F with a sixth inspection plan 134F, the seventh zone 124G with a seventh inspection plan 134G, and the eighth zone 124H with an eighth inspection plan 134H. Each one of the plurality of inspection plans 134 is different from one another, as each inspection plan is tailored to address the specific inspection requirements, anomaly types, or structural considerations within the corresponding zone 124.

Referring to FIG. 2B, at least one of the plurality of zones 124 of the digital representation can be further subdivided into a plurality of sub-zones 126. As described above, each zone 124 provides a distinct inspection area within the digital representation 120; however, in some examples, at least one of the plurality of zones 124 may be further divided into sub-zones 126 to provide a more granular level of anomaly management and inspection planning. For example, within the first segment 122A, the first zone 124A may be subdivided into a first sub-zone 126A, and a second sub-zone 126B, while the fifth zone 124E may be subdivided into a third sub-zone 126C and a fourth sub-zone 126D. Similarly, other ones of the plurality of zones 124 may be subdivided into multiple sub-zones. The number and size of sub-zones 126 within each zone 124 may be dynamically adjusted based on factors such as anomaly density, inspection requirements, or accessibility constraints. As with the segmentation and zoning structure, the subdivision into sub-zones helps ensure that inspections can be conducted at an appropriate level of detail without compromising efficiency. For simplicity, not all sub-zones 126 are labeled in FIGS. 2B-6, and additional sub-zones may be present within the digital representation 120 of the structure .

When a pre-divided zone (i.e., parent zone) is subdivided into a plurality of sub-zones 126, the inspection plan previously associated with the parent zone is no longer applied at the zone level, and instead, each sub-zone 126 is assigned a corresponding one of a plurality of inspection plans. Each sub-zone inspection plan is tailored to the specific characteristics and inspection requirements of the respective sub-zone and is different from both the original inspection plan of the parent zone and the inspection plans of other sub-zones. For example, the first sub-zone 126A is associated with a first sub-zone inspection plan 134A-1, and the second sub-zone 126B is associated with a second sub-zone inspection plan 134A-2, where 134A-1 and 134A-2 are different inspection plans. Likewise, additional sub-zones are each associated with a corresponding inspection plan tailored to the specific characteristics and inspection requirements of the respective sub-zone. For simplicity, not all inspection plans 134 are labeled in FIGS. 2B-6, and additional inspection plans may be present within the digital representation 120 of the structure .

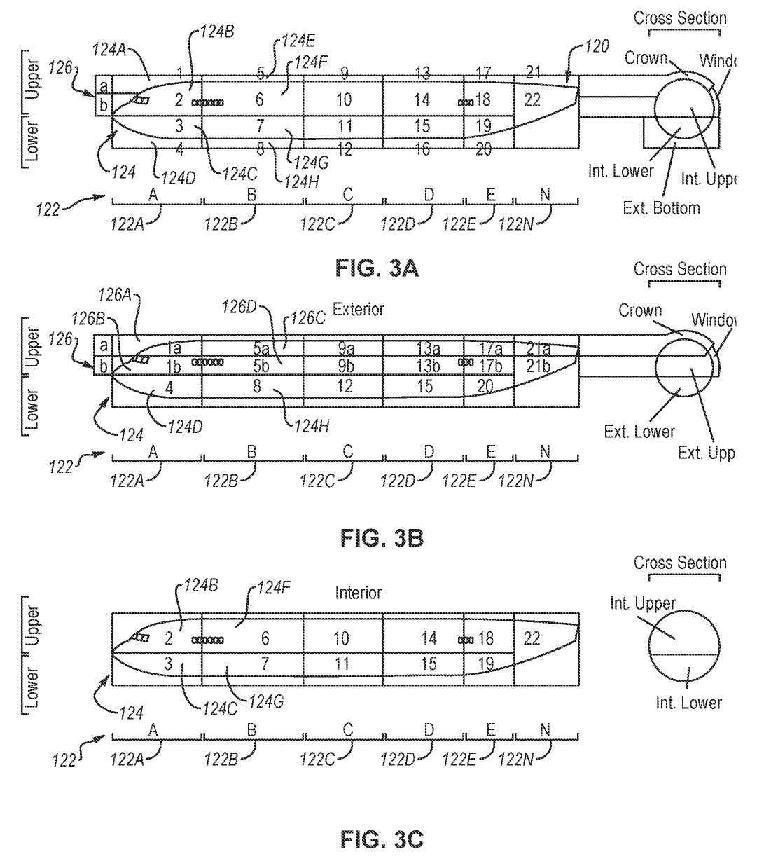

As shown in FIGS. 3A-3C, the plurality of zones 124 is visually represented on a graphical visualization of the digital representation 120 of the structure. In this example, the digital representation 120 of the structure corresponds to a fuselage, which has been segmented into a plurality of segments 122 along its length. Within each one of the plurality of segments 122, a plurality of zones 124 has been defined to organize inspection areas. FIG. 3A illustrates an example where the plurality of zones 124 are defined across the digital representation of the fuselage, with each zone visually delineated by distinct boundaries. The digital representation of the fuselage is divided into both exterior and interior portions along its length. For example, the first segment 122A includes the first zone 124A, the second zone 124B, the third zone 124C, and the fourth zone 124D, and the second segment 122B includes the fifth zone 124E, the sixth zone 124F, the seventh zone 124G, and the eighth zone 124H.

FIG. 3B focuses on exterior zones of the digital representation of the fuselage, with the exterior divided into an upper exterior section and a lower exterior section. Additionally, the upper exterior section is further sub-divided into sub-zones, including an upper crown section and an upper window section, to allow for more detailed inspections of specific structural areas. For example, the first segment 122A includes the first zone 124A sub-divided into the first sub-zone 126A and the second sub-zone 126B, as well as the fourth zone 124D. FIG. 3C focuses on the interior zones of digital representation of the fuselage, which are similarly divided into an upper interior section and a lower interior section. For example, the first segment 122A includes the second zone 124B and the third zone 124C. The digital representation may be defined into zones and sub-zones in this manner to accommodate accessibility constraints, optimize inspection coverage, and ensure structural areas receive appropriate attention during anomaly assessments.

Referring back to FIG. 1, the mapping module 108 is configured to map a plurality of anomalies identified by an anomaly identification system to corresponding locations within the digital representation of the structure. The anomaly identification system refers to a system, device, or combination of technologies configured to detect, record, and classify anomalies in a structure. The anomaly identification system may include automated inspection tools, such as non-destructive testing (NDT) equipment (e.g., ultrasonic, eddy current, or radiographic inspection systems), optical or infrared imaging devices, laser scanning systems, or other sensor-based detection mechanisms. Additionally, the anomaly identification system may incorporate manual inspection, including inspection reports, maintenance logs, and NC reports generated by inspectors.

The mapping module 108 processes anomaly data obtained from the anomaly identification system and determines the specific location of each anomaly within the digital representation of the structure. The location may be mapped using coordinate-based references, structural identifiers, or predefined reference points to establish a precise positional relationship between the anomaly and the structure. For example, the mapping module 108 may utilize data from anomaly records, CAD models, digital twin technology, barcoding, RFID systems, and other inspection tools to determine and log anomaly locations relative to the digital representation of the structure.

In some examples, anomaly characteristics are determined for each one of the plurality of anomalies 114 identified by the anomaly identification system. Anomaly characteristics refer to various attributes that define the nature and status of an anomaly. These anomaly characteristics may include, but are not limited to, the location of the anomaly within the digital representation of the structure, a type of anomaly(e.g., corrosion, crack, fastener issue, or surface damage), a size of the anomaly, a severity level of the anomaly, and a status of the anomaly (e.g., newly detected, under evaluation, or resolved). By capturing and organizing anomaly characteristics, the mapping module 108 may ensure that each anomaly is classified and prioritized within the inspection and repair workflow. For example, anomalies with a higher severity level may be flagged for immediate corrective action, while minor anomalies may be monitored over time.

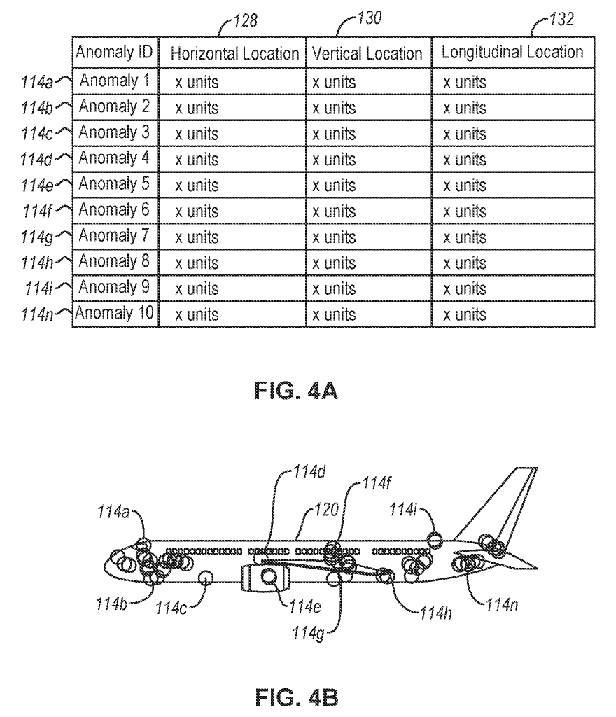

As shown in FIG. 4A, in some examples, the plurality of anomalies 114 identified by the anomaly identification system are identified by a three-point location, which are used to identify locations within the digital representation of the structure. Specifically, anomalies labeled as Anomaly1 through Anomaly10, 114A-114N, respectively, are shown in the table of FIG. 4A. The table provides the three-point location data for each anomaly, including a horizontal position 128 , a vertical position 130, and a longitudinal position 132. The three-point location is defined relative to a reference plane, which serves as a fixed coordinate system used to define spatial positions of anomalies within the digital representation 120 of the structure . For example, in an aircraft application, the reference plane may correspond to a predefined structural datum, such as the aircraft centerline or a manufacturing reference grid. As illustrated in FIG. 4B, the anomalies 114A-14N, along with other identified anomalies, are mapped along these three axes to provide precise localization within the digital representation 120 of the structure for each one of the plurality of anomalies.

The three-point location provides a precise spatial definition of each anomaly114 in the digital representation 120 of the structure . The horizontal position 128 is measured along a first axis parallel to the reference plane, defining the lateral displacement of the anomaly within the digital representation. The vertical position 130 is measured along a second axis perpendicular to the reference plane, defining the relative height or depth of the anomaly within the digital representation. The longitudinal position 132 is measured along a third axis extending along a length of the digital representation and intersecting the reference plane, defining the location of the anomaly along a length of the digital representation 120 of the structure .

In other examples, the plurality of anomalies 114, or at least some of the plurality of anomalies 114, may be identified by methods other than a three-point location system. For example, anomalies may be assigned based on predefined structural references, such as an identified component (e.g., a special panel, fastener, or structural joint), without requiring explicit spatial coordinates. Alternatively, anomalies may be categorized by functional zones, where an anomaly is associated with an operational system rather than a physical location, such as anomalies related to a pressurization system, avionics, or hydraulic system in the aircraft. In some cases, an anomaly may be assigned across the entire digital representation of the structure, such as when the anomaly pertains to global issues affecting multiple areas (e.g., material degradation, environmental exposure effects, or systemic manufacturing inconsistencies). In such cases, the anomaly is dynamically associated with each one of the plurality of zones 124 to ensure comprehensive inspection coverage and anomaly tracking.

The anomaly association module 110 is configured to dynamically associate each one of the plurality of anomalies with a corresponding one of the plurality of zones. That is, while the mapping module 108 determines the fixed location of each anomaly within the digital representation of the structure, the anomaly association module 110 ensures that each anomaly remains associated with the correct zone as zone boundaries are adjusted or sub-divided within the digital representation. In particular, the association of a anomaly within a zone is automatically updated whenever the plurality of zones are adjusted. Because zones are dynamically adjustable, an anomaly initially assigned to one zone may be reassigned to a different zone or sub-zone as zone boundaries shift, sub-zones are introduced, or inspection priorities evolve. However, the anomaly’s physical location within the digital representation remains unchanged; only its zone assignment is updated to reflect the most current zoning configuration. This ensures that anomaly tracking, inspection planning, and corrective actions remain aligned with the latest zone definitions.

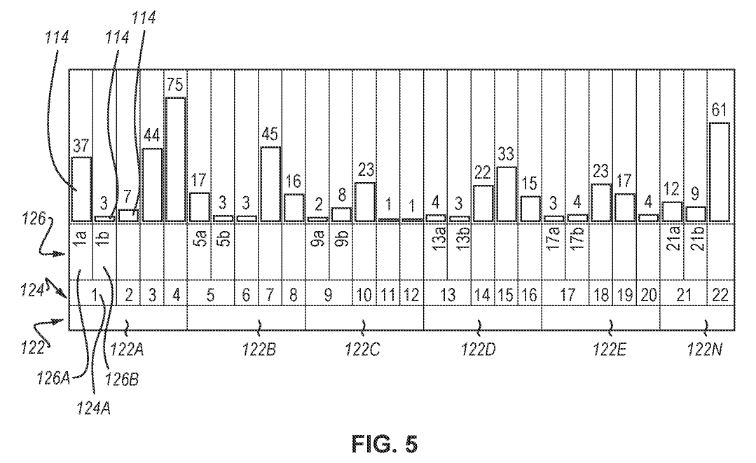

In some examples, the anomaly association module 110 is configured to update the digital representation 120 of the structure in real-time. The real-time nature of the digital representation helps ensure that anomaly associations are continuously updated as new anomalies are identified, changes in anomaly status occur, or adjustments to the plurality of zones are made. FIG. 5 represents one example of how the digital representation may be visually rendered to display the plurality of anomalies 114, by anomaly density per zone. Accordingly, the anomaly association module 110 has dynamically associated each one of the plurality of anomalies 114 with a corresponding one of the plurality of zones 124. The anomaly distribution is visually represented, with the plurality of anomalies 114 mapped to specific ones of the plurality of zones 124 or the plurality of sub-zones 126 within the digital representation 120 of the structure . The anomalies associated with each zone are grouped along a horizontal axis according to their respective zone or sub-zone, while the vertical bars indicate the quantity of anomalies present within each zone. The visualization allows for a quick assessment of anomaly density across different zones. Because the digital representation is updated in real-time, changes in anomaly data are reflected dynamically to ensure that the apparatus maintains an accurate and current representation of the plurality of anomalies. That is, the digital representation is updated dynamically in response to anomaly changes, new anomaly identification, and zone adjustments. In other examples, anomaly data within the digital representation may be displayed in various ways, including tabular formats, heat maps, or other data visualization techniques.

Referring back to FIG. 1, the apparatus 100 further includes the inspection plan module 112, which is configured to automatically execute the inspection plan associated with each one of the plurality of zones and generate corresponding instructions for corrective actions. The inspection plan module 112 helps ensure that each anomaly within a given zone is evaluated according to the appropriate inspection criteria. Accordingly, the inspection plan module 112 facilitates systematic anomaly management by ensuring that inspection procedures are consistently applied based on the plan for each zone. In some examples, the plurality of inspection plans 134 may be updated dynamically to reflect adjustments in zone boundaries, newly identified anomalies, or changes in anomaly status.

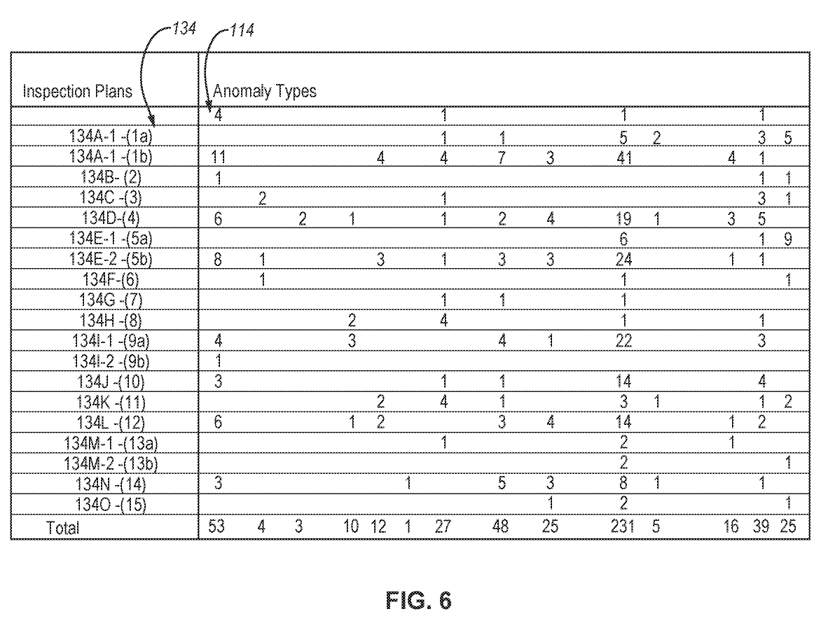

As shown in FIG. 6, each one of the plurality of zones 124 and plurality of sub-zones 126 within the digital representation 120 of the structure is associated with a corresponding inspection plan 134, which outlines the specific inspection requirements and procedures for that zone. In this example, an organized tabular format is represented where each inspection plan is associated to a corresponding zone or sub-zone and further lists the anomalies 114 contained within each respective zone. For example, a first sub-zone inspection plan 134A-1 is associated with the first sub-zone 126A and the corresponding plurality of anomalies 114, and a second sub-zone inspection plan 134A-2 is associated with the second sub-zone 126B and the corresponding plurality of anomalies 114. The inspection plan module 112 may use this structured data to ensure that all anomalies associated with a zone within the digital representation 120 of the structure are evaluated according to the inspection plan.

Once the inspection plan is executed, the inspection plan module 112 generates instructions to guide corrective actions for each one of the plurality of anomalies. The instructions associated with each corresponding one of the plurality of anomalies are generated according to the inspection plan for the zone associated with the corresponding one of the plurality of anomalies. The inspection plan may define general inspection procedures applicable to all areas of the zone, as well as more detailed steps for assessing specific anomalies. For example, the instructions may specify repair procedures, additional testing requirements, or follow-up inspections to verify anomaly resolution. The generated instructions serve as actionable guidance for the corrective actions that are configured to be performed on the physical structure. The instructions help ensure that anomaly identification, assessment, and resolution remain systematically aligned between the digital representation and the physical implementation of correction actions. The apparatus 100 operates as part of a broader, non-conformance anomaly management system 200, which integrates anomaly management functionality across a real structure.

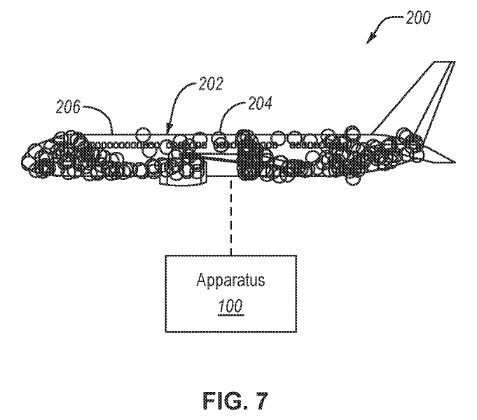

Referring to FIG. 7, a non-conformance anomaly management system 200 (herein after “system”) is provided for monitoring, evaluating, and addressing anomalies within a structure 202 (i.e., physical structure). As shown, the structure 202 is a fuselage 206. The structure 202 includes a plurality of anomalies 204 where each one of the plurality of anomalies requires at least one corrective action. The system 200 further includes the apparatus 100, which is configured to generate a digital representation of the structure and utilize the digital representation for anomaly management. Specifically, the apparatus 100 is configured to define a plurality of zones, map the plurality of anomalies within the digital representation of the structure, dynamically adjust the size of the zones based on operational requirements, map the plurality of anomalies within the digital representation, dynamically associate the plurality of anomalies with a corresponding one of the plurality of zones, and automatically execute an inspection plan associated with the corresponding zone. The digital representation allows for real-time updates as new anomalies are identified, anomaly statuses change, or zones are adjusted.

At least one corrective action is performed on the structure 202 for each one of the plurality of anomalies 204 of the structure 202 based on the instructions generated by the apparatus 100. The corrective actions are determined according to the inspection plan associated with the corresponding zone in the digital representation of the structure. Corrective actions may include, but are not limited to, repair procedures, rework guidelines, additional diagnostic tests, or follow-up inspections. The corrective actions are then carried out on the structure 202 to ensure anomaly resolution for each one of the plurality of anomalies.

The system 200 may also be configured to interface with external work order management systems to facilitate structured anomaly resolution workflows. In some examples, once an inspection plan is executed and corrective actions are determined, the system 200 can generate a corresponding work order or provide anomaly resolution data that can be integrated into an external work order system. This may allow for end-to-end traceability from anomaly identification to resolution, to ensure that corrective actions are documented, assigned, and tracked efficiently.

In some examples, the digital representation allows for real-time tracking of corrective actions, to ensure that the status of each anomaly is continuously updated as actions are performed. This enables a comprehensive anomaly management workflow where corrective actions are systematically executed, monitored, and validated within their respective zone or sub-zone.

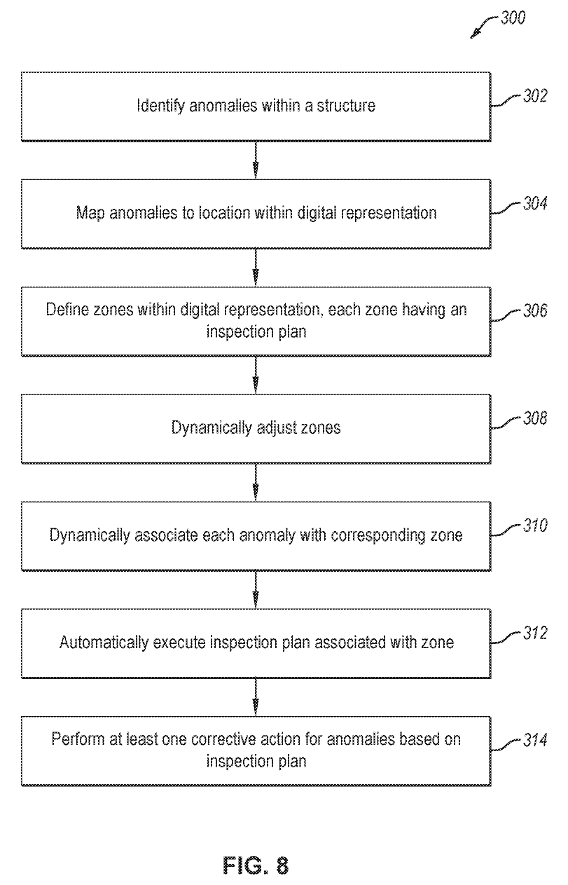

Referring to FIG. 8, and according to one example, a method 300 of managing non-conformance anomalies in a structure 202 is shown. The method 300 includes (block 302) identifying a plurality of anomalies within the structure using an anomaly identification system. The anomaly identification system may include automated inspection tools or manual inspection data. The method 300 also includes (block 304) mapping each one of the plurality of anomalies to corresponding locations within a digital representation of the structure. The mapping process assigns a spatial reference to each anomaly using coordinate-based references, structural identifiers, or predefined reference points within the digital representation. For example, an anomaly may be mapped relative to a reference plane using a three-point location (e.g., horizontal, vertical, and longitudinal coordinates).

The method 300 further includes (block 306) defining a plurality of zones within the digital representation of the structure. A size of each one of the plurality of zones is dynamically adjustable and associated with a corresponding one of a plurality of inspection plans that are different from one another. Zones may be defined based on structural divisions, functional roles, or stages or assembly to help with targeted inspections and efficient anomaly management. The method 300 additionally includes (block 308) dynamically adjusting at least one of the plurality of zones within the digital representation of the structure based on operational requirements. Adjustments to zones may occur due to changes in inspection priorities, anomaly distributions, accessibility constraints, or evolving structural configurations. The ability to dynamically adjust zones help to ensure that anomaly assessments remain aligned with real-time operational requirements.

The method 300 also includes (block 310) dynamically associating each one of the plurality of anomalies with a corresponding one of the plurality of zones within the digital representation of the structure. This ensures that anomalies are continuously tracked within the corresponding zone, even if zone boundaries are modified. The method 300 further includes (block 312) automatically executing the inspection plan associated with the corresponding one of the plurality of zones. The execution of the inspection plan involves applying predefined inspection procedures, criteria, and evaluation techniques to assess anomalies within each zone. The inspection plan may define general inspection steps application to all areas of a zone, as well as specific procedures tailored to particular anomalies.

Additionally, the method 300 includes (block 314) performing at least one corrective action for each one of the plurality of anomalies within the structure according to the inspection plan for the zone associated with the corresponding one of the plurality of anomalies. Corrective actions may include repairs, component replacements, structural reinforcements, additional testing, or re-inspections. In some examples, once a corrective action is performed, the digital representation is updated in real-time to reflect the status of the anomaly.

In some examples, the method 300 further includes subdividing at least one of the plurality of zones within the digital representation of the structure into a plurality of sub-zones. Each sub-zone is dynamically adjustable and is associated with a corresponding inspection plan that defines the inspection criteria. Additionally, or alternatively, in some examples, the method 300 includes defining segments within the digital representation of the structure, where each segment corresponds to a predefined portion of the digital representation. Segmentation enables a structural organization of the digital representation, facilitating zone definition within distinct portions of the structure.

Additionally, in some examples, the method 300 includes generating the digital representation of the structure in real-time based on at least one of newly identified anomalies, changes in anomaly status, or adjustments to the plurality of zones. The real-time updates ensure that anomaly management operations remain current, reflecting ongoing modifications to the plurality of zones, anomaly statuses, and corrective actions.

In the above description, certain terms may be used such as "up," "down," "upper," "lower," "horizontal," "vertical," "left," "right," “over,” “under” and the like. These terms are used, where applicable, to provide some clarity of description when dealing with relative relationships. But, these terms are not intended to imply absolute relationships, positions, and/or orientations. For example, with respect to an object, an "upper" surface can become a "lower" surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/-5% of a given value, however in additional embodiments any disclosure of “about” may be further narrowed and claimed to mean within +/- 4% of a given value, within +/- 3% of a given value, within +/- 2% of a given value, within +/- 1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms "first," "second," etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object oriented programming language such as Python, Ruby, Java, Smalltalk, C++, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The described features, structures, or characteristics of the examples may be combined in any suitable manner. In the above description, numerous specific details are provided, such as examples of programming, software modules, user selections, network transactions, database queries, database structures, hardware modules, hardware circuits, hardware chips, etc., to provide a thorough understanding of examples. One skilled in the relevant art will recognize, however, that examples may be practiced without one or more of the specific details, or with other methods, components, materials, and so forth. In other instances, well-known structures, materials, or operations are not shown or described in detail to avoid obscuring aspects of an example.

Aspects of the examples are described above with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods and program products according to various examples. In this regard, each block in the schematic flowchart diagrams and/or schematic block diagrams may represent a module, segment, or portion of code, which comprises one or more executable instructions of the code for implementing the specified logical function(s).

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus for managing non-conformance anomalies in a structure, the apparatus comprising:
a processor; and
a memory that stores code executable by the processor to:
define a plurality of zones within a digital representation of the structure, wherein:
a size of each one of the plurality of zones is dynamically adjustable; and
each one of the plurality of zones is associated with a corresponding one of a plurality of inspection plans that are different from one another;
dynamically adjust the size of at least one of the plurality of zones based on operational requirements of the digital representation of the structure;
map a plurality of anomalies identified by an anomaly identification system to corresponding locations within the digital representation of the structure;
dynamically associate each one of the plurality of anomalies with a corresponding one of the plurality of zones within the digital representation of the structure;
automatically execute the inspection plan associated with the zone of the plurality of zones; and
generate instructions to guide at least one corrective action for each one of the plurality of anomalies, wherein the instructions associated with each corresponding one of the plurality of anomalies are generated according to the inspection plan for the zone associated with the corresponding one of the plurality of anomalies.

2. The apparatus of claim 1, wherein the memory further stores code executable by the processor to:
subdivide at least one of the plurality of zones into a plurality of sub-zones within the digital representation of the structure, wherein:
a size of each one of the plurality of sub-zones is dynamically adjustable; and
each one of the plurality of sub-zones is associated with a
corresponding one of a plurality of inspection plans that are
different from one another;
dynamically associate at least one of the plurality of anomalies with a corresponding one of the plurality of sub-zones within the digital representation of the structure;
automatically execute the inspection plan associated with the sub-zone of the plurality of sub-zones; and
generate instructions to guide at least one correction action for each one of the plurality of anomalies associated within the plurality of sub-zones, wherein the instructions associated with each corresponding one of the plurality of anomalies are generated according to the inspection plan for the sub-zone associated with the corresponding one of the plurality of anomalies.

3. The apparatus of claim 1, wherein the memory further stores code executable by the processor to:
define a plurality of segments within the digital representation of the structure, wherein:
each one of the plurality of segments represents a predefined portion of the digital representation; and
the plurality of segments are configured to organize the digital representation of the structure into identifiable regions for managing the plurality of anomalies; and
define at least one of the plurality of zones within a corresponding one of the plurality of segments within the digital representation of the structure.

4. The apparatus of claim 1, wherein each corresponding one of the plurality of anomalies identified by the anomaly identification system is identified by a three-point location within the digital representation of the structure, wherein the three-point location is defined relative to a reference plane and includes:
a horizontal position measured along a first axis parallel to the reference plane;
a vertical position measured along a second axis perpendicular to the reference plane; and
a longitudinal position measured along a third axis extending along a length of the digital representation of the structure and intersecting the reference plane.

5. The apparatus of claim 4, wherein the three-point location of each corresponding one of the plurality of anomalies is used to dynamically associate each corresponding one the plurality of anomalies with a corresponding one of the plurality of zones within the digital representation of the structure.

6. The apparatus of claim 1, wherein the step of defining a plurality of zones within the digital representation of the structure comprises automatically defining each one of the plurality of zones based on operational requirements of the digital representation of the structure and automatically associating the inspection plan corresponding to each one of the plurality of zones.

7. The apparatus of claim 1, wherein the step of defining a plurality of zones within the digital representation of the structure comprises enabling a user to manually define boundaries for each one of the plurality of zones and manually associating the inspection plan corresponding to each one of the plurality of zones.

8. The apparatus of claim 1, wherein anomaly characteristics are determined for each one of the plurality of anomalies identified by the anomaly identification system, the anomaly characteristics comprising at least one of:
a location of each one of the plurality of anomalies;
a type of each one of the plurality of anomalies;
a size of each one of the plurality of anomalies;
a severity level of each one of the plurality of anomalies; and
a status of each one of the plurality of anomalies.

9. The apparatus of claim 1, wherein the digital representation of the structure is updated in real-time based on at least one of newly identified anomalies, changes in anomaly status of at least one the plurality of anomalies, or adjustments to the plurality of zones.

10. A non-conformance anomaly management system comprising:
a structure comprising a plurality of anomalies, wherein each one of the plurality of anomalies requires at least one corrective action; and
an apparatus comprising;
a processor; and
a memory that stores code executable by the processor to:
define a plurality of zones within a digital representation of the structure, wherein:
a size of each one of the plurality of zones is dynamically adjustable; and
each one of the plurality of zones is associated with a corresponding one of a plurality of inspection plans that are different from one another;
dynamically adjust the size of at least one of the plurality of zones based on operational requirements of the digital representation of the structure;
map a plurality of anomalies identified by an anomaly identification system to corresponding locations within the digital representation of the structure;
dynamically associate each one of the plurality of anomalies with a corresponding one of the plurality of zones within the digital representation of the structure;
automatically execute the inspection plan associated with the zone of the plurality of zones; and
generate instructions to guide at least one corrective action for each one of the plurality of anomalies, wherein the instructions associated with each corresponding one of the plurality of anomalies are generated according to the inspection plan for the zone associated with the corresponding one of the plurality of anomalies; and
wherein the at least one corrective action is performed for each one of the plurality of anomalies of the structure based on the instructions generated by the apparatus derived from the digital representation of the structure.

11. The non-conformance anomaly management system of claim 10, wherein the memory further stores code executable by the processor to:
subdivide at least one of the plurality of zones into a plurality of sub-zones within the digital representation of the structure, wherein:
a size of each one of the plurality of sub-zones is dynamically adjustable; and
each one of the plurality of sub-zones is associated with a corresponding one of a plurality of inspection plans that are different from one another;
dynamically associate at least one of the plurality of anomalies with a corresponding one of the plurality of sub-zones within the digital representation of the structure;
automatically execute the inspection plan associated with the sub-zone of the plurality of sub-zones; and
generate instructions to guide at least one correction action for each one of the plurality of anomalies associated within the plurality of sub-zones, wherein the instructions associated with each corresponding one of the plurality of anomalies are generated according to the inspection plan for the sub-zone associated with the corresponding one of the plurality of anomalies.

12. The non-conformance anomaly management system of claim 10, wherein the memory further stores code executable by the processor to:
define a plurality of segments within the digital representation of the structure, wherein:
each one of the plurality of segments corresponds to a predefined portion within the digital representation of the structure; and
the plurality of segments are configured to organize the digital representation of the structure into identifiable regions for managing the plurality of anomalies; and
define at least one of the plurality of zones within a corresponding one of the plurality of segments within the digital representation of the structure.

13. The non-conformance anomaly management system of claim 10, wherein each corresponding one of the plurality of anomalies identified by an anomaly identification system is identified by a three-point location within the digital representation of the structure, wherein the three-point location is defined within the digital representation relative to a reference plane and includes:
a horizontal position measured along a first axis parallel to the reference plane;
a vertical position measured along a second axis perpendicular to the reference plane; and
a longitudinal position measured along a third axis extending along a length of the structure and intersecting the reference plane.

14. The non-conformance anomaly management system of claim 10, wherein anomaly characteristics are determined for each one of the plurality of anomalies identified by the anomaly identification system, the anomaly characteristics comprising at least one of:
a location of each one of the plurality of anomalies;
a type of each one of the plurality of anomalies;
a size of each one of the plurality of anomalies;
a severity level of each one of the plurality of anomalies; and
a status of each one of the plurality of anomalies.

15. The non-conformance anomaly management system of claim 10, wherein the digital representation of the structure is updated in real-time based on at least one of newly identified anomalies, changes in anomaly status of at least one the plurality of anomalies, or adjustments to the plurality of zones.

16. A method of managing non-conformance anomalies in a structure, the method comprising:
identifying a plurality of anomalies within the structure using a anomaly identification system;
mapping each one of the plurality of anomalies to corresponding locations within a digital representation of the structure;
defining a plurality of zones within the digital representation of the structure, a size of each one of the plurality of zones being dynamically adjustable and associated with a corresponding one of a plurality of inspection plans that are different from one another;
dynamically adjusting at least one of the plurality of zones within the digital representation of the structure based on operational requirements of the structure;
dynamically associating each one of the plurality of anomalies with a corresponding one of the plurality of zones within the digital representation of the structure;
automatically executing the inspection plan associated with the corresponding one of the plurality of zones; and
performing at least one corrective action for each one of the plurality of anomalies within the structure according to the inspection plan for the zone associated with the corresponding one of the plurality of anomalies.

17. The method of claim 16, further comprising subdividing at least one of the plurality of zones within the digital representation of the structure into a plurality of sub-zones, wherein a size of each one of the plurality of sub-zones is dynamically adjustable and each one of the plurality of sub-zones is associated with a corresponding one of a plurality of inspection plans.

18. The method of claim 16, further comprising:
defining the digital representation of the structure into a plurality of segments, wherein each one of the plurality of segments corresponds to a predefined portion of the digital representation of the structure; and
defining at least one of the plurality of zones within a corresponding one of the plurality of segments in the digital representation of the structure.

19. The method of claim 16, further comprising determining a three-point location within the digital representation of the structure for each one of the plurality of anomalies relative to a reference plane, the three-point location including a horizontal position, a vertical position, and a longitudinal position.

20. The method of claim 16, further comprising generating the digital representation of the structure, in real-time, based on at least one of newly identified anomalies, changes in anomaly status for at least one of the plurality of anomalies, or adjustments to the plurality of zones.
